(19) United States
(12) Patent Application Publication
(10) Pub. No.: US 2020/0020177 A1
(43) Pub. Date: Jan. 16, 2020

(54) SYSTEM AND METHOD FOR ASSISTING IN THE START OF A MOTOR VEHICLE RACE

(71) Applicant: Continental Automotive Systems, Inc., Auburn Hills, MI (US)

(72) Inventor: Ryan Stabel, Grand Blanc, MI (US)

(73) Assignee: Continental Automotive Systems, Inc., Auburn Hills, MI (US)

(21) Appl. No.: 16/507,655

(22) Filed: Jul. 10, 2019

Related U.S. Application Data
(60) Provisional application No. 62/696,004, filed on Jul. 10, 2018.

(51) Int. Cl. G07C 1/24; G08G 1/095

(52) U.S. Cl. CPC G07C 1/24; G08G 1/095

(57) ABSTRACT

A race start assistance system and method includes sensing an external indication indicative of a forthcoming start of a vehicle race. A time of an actual start of the race is determined based on the sensed external indication. At least one signal is automatically sent to the vehicle to accelerate the vehicle at the actual start of the race in response to calculating the time of the actual start of the race.

### CROSS REFERENCE TO RELATED APPLICATION

This application claims the benefit of provisional patent application No. 62/696,004, filed Jul. 10, 2018, which is hereby incorporated by reference.

### TECHNICAL FIELD

The technical field relates generally to control systems and methods for motor vehicles and particularly to control systems and methods for assisting in controlling a motor vehicle in a race.

### BACKGROUND

Drag racing is a popular motorsport that is practiced both by professionals and amateur drivers. The sport typically pits two drivers against one another on a straight track or roadway. Prior to the start of the race, each driver typically performs a “burnout” on the track to heat and/or clean the tires by applying the accelerator to rotate the drive wheels while simultaneously applying the brakes to the non-drive wheels to hold the vehicle in place.

After performing the burnout, each driver will maneuver their vehicle near a start line. Once both vehicles are lined up, an indication is given to start the race. At that point, each driver operates their vehicle on the track (or roadway) for a predetermined distance to a finish line. Typically, the vehicle arriving first at the finish line is the winner.

As can be surmised, numerous factors are involved in determining the winner of the race. These factors may include, but are not limited to, various characteristics of the vehicle (e.g., performance of the engine and transmission, type and size of tires, etc.), human factors (e.g., reaction time of the driver, the ability to anticipate the start of the race, operation of the vehicle, etc.), weather, and so on.

As such, it is desirable to present a system and method that assists in operating a motor vehicle in a race. In addition, other desirable features and characteristics will become apparent from the subsequent summary and detailed description, and the appended claims, taken in conjunction with the accompanying drawings and this background.

### BRIEF SUMMARY

According to one exemplary embodiment, a race start assistance method for a vehicle includes sensing an external indication indicative of a forthcoming start of a race. The method also includes calculating a time of an actual start of the race based on the sensed external indication. The method further includes automatically sending at least one signal to the vehicle to accelerate the vehicle at the actual start of the race in response to calculating the time of the actual start of the race.

According to one exemplary embodiment, a system for assisting in the start of a motor vehicle race includes a sensor for sensing an external indication indicative of a forthcoming start of the motor vehicle race. The system also includes a processor in communication with the sensor configured to calculate a time of an actual start of the race based on the sensed external indication. The system further includes a communications module in communication with the processor and configured to automatically send at least one signal to the vehicle to accelerate the vehicle at the actual start of the race in response to calculating the time of the actual start of the race.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block schematic diagram of a system for assisting in the start of a motor vehicle race according to one exemplary embodiment;

FIG. 2 is a front view of a Christmas tree lighting system providing an external indication of the start of the motor vehicle race according to one exemplary embodiment;

FIG. 3 is a block view of a drag racing track according to one exemplary embodiment; and

FIG. 4 is a flowchart of a race start assistance method according to one exemplary embodiment.

### DETAILED DESCRIPTION

Referring to the Figures, wherein like numerals indicate like parts throughout the several views, a system 100 for assisting in the start of a motor vehicle race and a race start assistance method 400 for a motor vehicle 102 is shown and described herein.

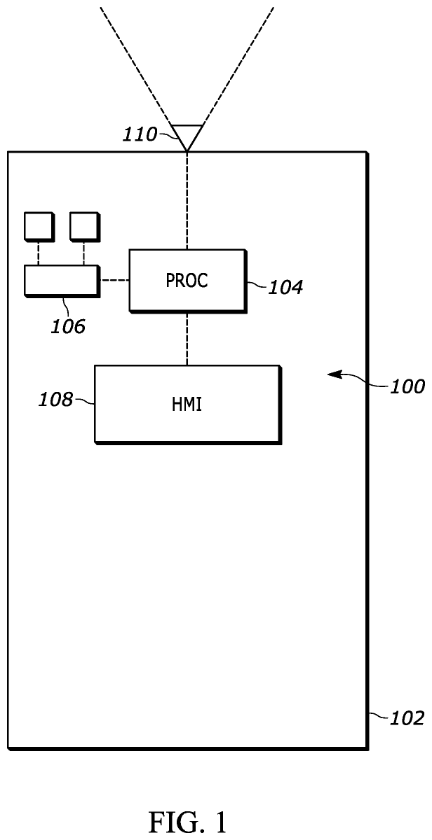

Referring to FIG. 1, the system 100 includes a processor 104. The processor 104 is a computing device capable of performing mathematical calculations and/or executing instructions (e.g., running a program). The processor 104 may be implemented with at least one microprocessor, microcontroller, integrated circuit, application specific integrated circuit (“ASIC”), and/or any other suitable device, as is appreciated by those of ordinary skill in the art. The processor 104 includes one or more inputs (not shown) and outputs (not shown) for receiving and/or sending data, as is also appreciated by those skilled in the art.

The system 100 may also include a communication module 106. The communications module 106 is in communications with the processor 104 and serves as an interface between the processor 104 and the motor vehicle 102. Said another way, the communications module 106 is configured to send data and/or signals to/from the processor 104 to one or more systems (not shown) and/or controls (not shown) of the motor vehicle 102, and vice-versa. The communications module 106 may be integrated with the processor 104, i.e., disposed in one physical unit, or be separate. However, it should be appreciated that the system 100 may be implemented without the communications module 106, i.e., with vehicle systems in direct communication with the processor 104.

As eluded to above, the processor 104 may be in communication with one or more vehicle systems and controls. For instance, the processor 104 may send signals to control the brakes and the throttle of the vehicle. The processor 104 may also receive signals from a wheel speed sensor, an engine speed sensor, an accelerometer, a throttle position sensor, a brake position sensor, a steering wheel position sensor, a transmission gear position sensor, and a turbo charger boost level sensor. Of course, the processor 104 and/or the communications module 106 may be in communications with any other vehicle system or device.

The system 100 may also include a human-machine interface (“HMI”) 108 in communication with the processor. The HMI 108 is configured to provide an interface between an operator of the motor vehicle 102 and the processor. As such, the HMI 108 is configured to send and/or receive data, information, instructions, and/or commands.

The HMI 108 in one exemplary embodiment is a display (not shown) with a touch-screen interface (not shown). In one exemplary embodiment, the HMI 108 may be integrated in a cellular telephone, e.g., a smartphone. However, it should be appreciated that the HMI 108 may be implemented with any suitable combinations of switches, buttons, displays, lights, microphones, speakers, etc., as will be readily appreciated by those skilled in the art.

The system 100 also includes an external indication sensor 110. The external indication sensor 110 is configured to sense an external indication 200 indicative of a forthcoming start of a motor vehicle race. In one exemplary embodiment, the sensor 110 is implemented as a camera (not separately numbered) to sense at least part of the environment outside of the vehicle 102 using imaging technology, as appreciated by those skilled in the art. However, it should be appreciated that other devices may be utilized to implement the sensor 110, e.g., a lidar system, a microphone, or a radio receiver.

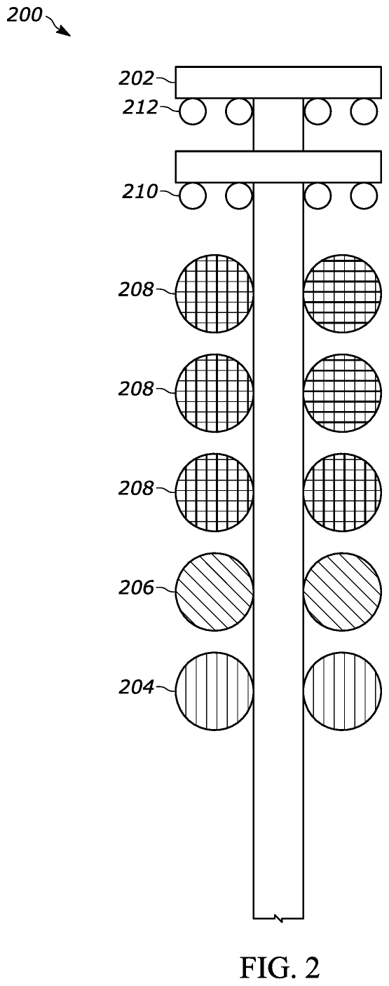

Referring now to FIG. 2, the external indication 200 in one exemplary embodiment is a Christmas tree lighting system 202. The Christmas tree lighting system is a well-known apparatus often used to start drag races between two motor vehicles. In the exemplary embodiment shown in FIG. 2, the Christmas tree lighting system 202 includes a plurality of lights arranged in two columns (not numbered) with each column associated with a vehicle involved in the drag race. The lights in each column include, starting from the bottom and going up, a red light 204, a green light 206, three amber lights 208, at least one stage indicator light 210, and at least one pre-stage indicator light 212. It should be appreciated that the lights 204, 206, 208, 210, 212, 214 may be implemented using any known lighting techniques (incandescent, LED, etc.) and that other embodiments of the Christmas tree lighting system 202 may be alternately implemented.

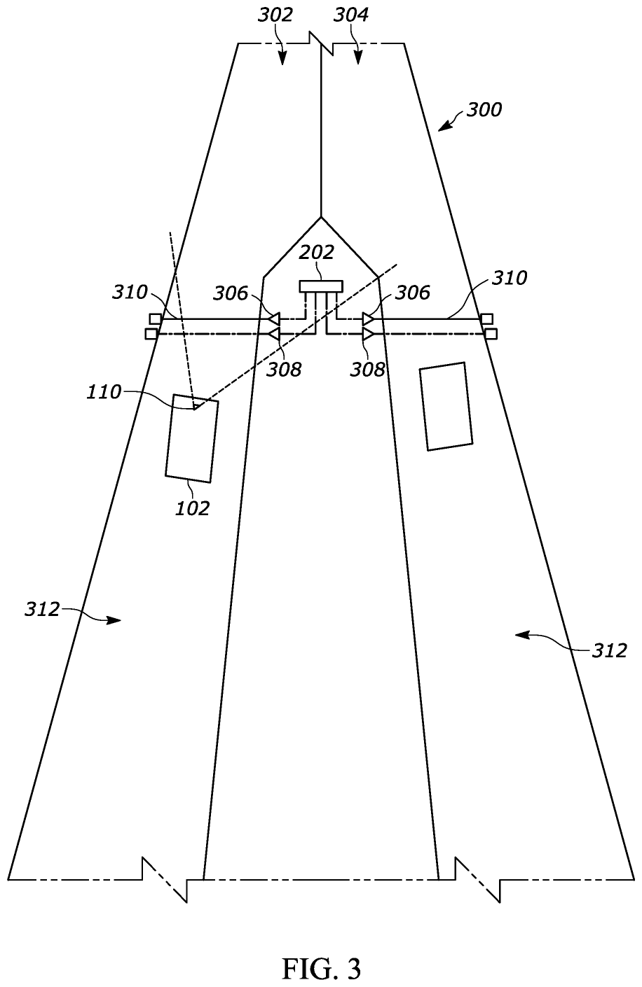

An exemplary drag racing track 300 is shown in FIG. 3. In this example, the Christmas tree lighting system 200 is disposed between two driving lanes 302, 304. The track 300 includes a first sensor assembly 306 and a second sensor assembly 308 situated adjacent to each driving lane 302, 304. Each sensor assembly 306, 308 includes a light source (not shown) and a photo detector (not shown) to generate a beam of light (not numbered) across the respective driving lane 302, 304 that may be interrupted by the vehicle 102, as is well known to those skilled in the art.

The first sensor assembly 306 generates a beam of light at a starting line 310 on the track while the second sensor assembly 308 is disposed between the starting line 310 and a burnout area 312. More specifically, in the exemplary embodiment, the second sensor assembly 308 is disposed about 7 inches (17.8 cm) prior to the starting line 310.

The vehicle will interrupt the beam of light of the second sensor assembly 308 as it approaches the starting line 310. In response, the at least one pre-stage indicator light 212 will be illuminated to inform the driver that the vehicle is near the starting line 310. As the vehicle continues to advance toward the starting line 310, the beam of light of the first sensor assembly 306 is interrupted. In response, the at least one stage indicator light 210 is illuminated to inform the driver that the vehicle is now at the starting line 310.

After both vehicles are at the starting line 310, the Christmas tree lighting system 202 illuminates the amber lights 208, followed by the green lights 206. Illumination of the green lights 206 indicates the start of the race. In a first configuration, sometimes referred to as a “professional tree,” all of the amber lights 208 will illuminate simultaneously. The green lights 206 illuminate 0.4 seconds after the amber lights 208 illuminate. In a second configuration, sometimes referred to as a “standard tree,” the uppermost amber lights 208 illuminate first, followed 0.5 seconds later by the middle amber lights 208, then another 0.5 seconds later by the lowermost amber lights 208. The green lights 206 illuminate 0.5 seconds after the lowermost amber lights 208 illuminate.

Once the green lights 206 illuminate the vehicles may leave the starting line. However, if a vehicle leaves early, i.e., advances past the starting line before the green lights 206 illuminate, this is sensed by the beam of light of the first sensor assembly 306 and the red light 204 for that particular lane is illuminated to indicate a potential disqualification.

As such, when manually drag racing a vehicle, one major challenge is properly timing the beginning the acceleration of the vehicle. For instance, if the driver anticipates the green signal incorrectly, and begins to accelerate too soon, then they may be disqualified. On the other hand, if the driver waits until they see the green to being to accelerate, the other vehicle may have anticipated the green more closely, and is rewarded with a better start.

Referring again to FIG. 2, the camera of the exemplary embodiment is configured to obtain an image of a field of view in front of the vehicle including the external indication 200 indicative of the forthcoming start of the motor vehicle race, which, in this example, is the Christmas tree lighting system.

Referring again to FIG. 1, the processor 104 is in communication with the sensor 110. As such, the processor 104 may receive signals from the sensor 110, e.g., a video signal presenting the external indication 200 indicative of the forthcoming start of a motor vehicle race.

The processor 104 is configured to calculate a time of an actual start of the race based on the sensed external indication. For example, in the case of a standard tree, the actual start of the race would be 1.5 seconds after the uppermost amber lights 208 illuminate, 1 second after the middle amber lights 208 illuminate, and/or 0.5 seconds after the lowermost amber lights 208 illuminate.

The communications module 106 is in communication with the processor 104, as stated above, and is configured to automatically send at least one signal to the vehicle 102 to accelerate the vehicle 102 at the actual start of the race in response to calculating the time of the actual start of the race. The at least one signal may be sent to a throttle (i.e., an accelerator), an engine, a transmission, a launch or take-off device, and/or other equipment (not specifically shown) as appreciated by those skilled in the art. It should be noted that the time that the at least one signal is sent is not necessarily the time of the actual start of the race. Instead, the at least one signal may be sent earlier to ensure movement of the vehicle at, but not before, the start of the race, based on any number of variables. These variables may include, but are not limited to, delay times, vehicle weight, engine type, tire type and/or condition, fuel type, and transmission dynamics.

The communications module 106 may also be in communication with the braking system (not specifically shown) of the vehicle 102 to control operation of the brakes. For instance, the processor 104 and communications module 106, after sensing the external indication, may apply the front brakes of the vehicle 102 while moving the rear drive wheels of the vehicle to launch the vehicle as soon as the external indication indicates the start of the race (e.g., a green light).

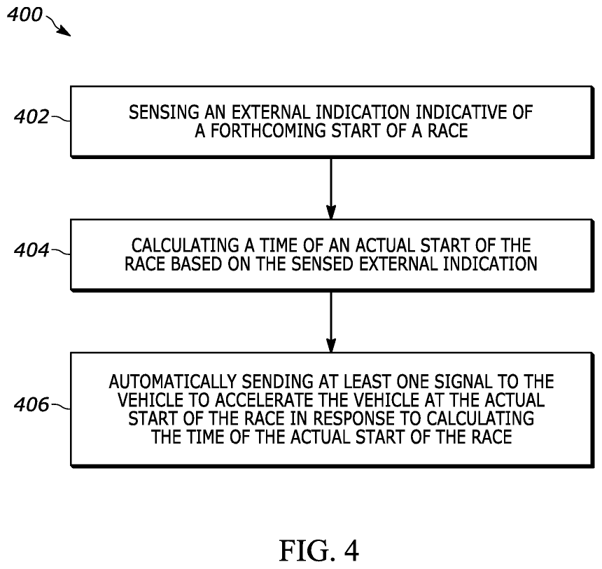

Referring now to FIG. 4, a race start assistance method 400 for the vehicle 102 is shown. The race start assistance method 400 may be implemented using the system 100 described above, or with another suitable system, device, and/or assembly.

The method 400 includes, at 402, sensing an external indication indicative of a forthcoming start of a race. In one exemplary embodiment, sensing an external indication indicative of a forthcoming start of a race may be accomplished by sensing the illumination of a yellow light of a Christmas tree lighting system. More particularly, sensing the illumination of at least one yellow light of the Christmas tree lighting system may be accomplished by analyzing an optical image showing the Christmas tree lighting system.

The method 400 also includes, at 404, calculating a time of an actual start of the race based on the sensed external indication. In one exemplary embodiment, calculating a time of an actual start of the race may be accomplished by recording a time when the yellow light of the Christmas tree lighting system illuminates and adding a predetermined time duration to the recorded time.

The method 400 further includes, at 406, automatically sending at least one signal to the vehicle to accelerate the vehicle at the actual start of the race in response to calculating the time of the actual start of the race.

In practice, an exemplary embodiment of the system 100 and method 400 may operate as follows. The driver of the vehicle 102 may maneuver the vehicle toward the starting line 310. The driver may then select a “Christmas tree monitoring auto-stage” option via the HMI 108. The HMI 108 then informs the driver to release the brake. The processor 104, utilizing the external indication sensor 110, would then monitor the pre-stage and stage lights 210, 212 of the Christmas tree lighting system 202. The processor 104 sends signals to the throttle and brakes of the vehicle 102 to move the vehicle to the starting line 310. Once the stage light 210 is illuminated, the processor 104 sends signals to brake and hold the vehicle 102 at the starting line 310.

The driver may then select “Christmas tree monitoring launch assist” via the HMI 108. In one embodiment, the driver may indicate whether a professional tree or a manual tree is used. Alternatively, the system may make this determination automatically based on the sensed illumination of the lights 204, 206, 208, 210, 212. In this example, the HMI 108 informs the driver to apply wide open throttle—however, the signal from the throttle pedal may not be sent to the engine. Once the actual start time of the race is calculated by monitoring the Christmas tree lighting system 202, the processor 104 controls launch of the vehicle 102 by sending signals to the throttle and brake accordingly.

The system 100 may also be configured to allow the driver of the vehicle 102 to perform a burnout prior to the race. In one example, the system 100 may be configured to perform a manual burnout coached by the system 100. First, the driver would maneuver the vehicle 102 to the burnout area 312. The driver may utilize the HMI to signal a coached burnout, e.g., by pressing a “coached burnout” icon on the touchscreen display. The HMI would then instruct the driver to apply the throttle and brake at the same time. The processor, utilizing wheel speed data, pre-programmed tire information, and/or other data, may further coach the driver to increase or decrease speed, and also inform the driver when the burnout is complete. In another example, the system 100 may be configured to perform an automatic burnout. After maneuvering to the burnout area 312, the driver may utilize the HMI to signal an automatic burnout, e.g., by pressing an “automatic burnout” icon on the display. The processor 104, after receiving the signal from the HMI, would then utilize the wheel speed data, pre-programmed tire information, and/or other data, to control the brakes and throttle of the vehicle to perform the burnout.

It should be appreciated that the external indication 200 may be implemented utilizing devices and techniques other than the Christmas tree lighting system. For instance, a flashlight (not shown), flag (not shown), or other device may be moved to indicate the start of the race. While such alternative indications may limit the ability of the system 100 to anticipate the start time of the race, the system 100 may still function in numerous ways to give the driver an advantage over the competition.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A race start assistance method for a vehicle, said method comprising:
sensing an external indication indicative of a forthcoming start of a race;
calculating a time of an actual start of the race based on the sensed external indication;
automatically sending at least one signal to the vehicle to accelerate the vehicle at the actual start of the race in response to calculating the time of the actual start of the race.

2. The method as set forth in claim 1, wherein sensing an external indication indicative of a forthcoming start of a race comprises sensing the illumination of a yellow light of a Christmas tree lighting system.

3. The method as set forth in claim 2, wherein sensing the illumination of at least one yellow light of the Christmas tree lighting system comprises analyzing an optical image showing the Christmas tree lighting system.

4. The method as set forth in claim 2, wherein calculating a time of an actual start of the race based on the sensed external indication comprises recording a time when the yellow light illuminates and adding a predetermined time duration to the recorded time.

5. A system for assisting in the start of a motor vehicle race, said system comprising:
a sensor for sensing an external indication indicative of a forthcoming start of the motor vehicle race;
a processor in communication with said sensor configured to calculate a time of an actual start of the race based on the sensed external indication; and
a communications module in communication with said processor and configured to automatically send at least one signal to the vehicle to accelerate the vehicle at the actual start of the race in response to calculating the time of the actual start of the race.

6. The system as set forth in claim 5, wherein said sensor comprises a camera configured to obtain an image of a field of view in front of the vehicle including the external indication indicative of the forthcoming start of the motor vehicle race.

7. The system as set forth in claim 5, further comprising a human-machine interface (“HMI”) in communication with said processor.

8. The system as set forth in claim 5, wherein said sensor is configured to sense the illumination of a yellow light of a Christmas tree lighting system in sensing the external indication indicative of a forthcoming start of the motor vehicle race.

9. The system as set forth in claim 8, wherein said sensor is configured to analyze an optical image showing the Christmas tree lighting in sensing the illumination of at least one yellow light of the Christmas tree lighting system.

10. The method as set forth in claim 5, wherein said processor is configured to record a time when the yellow light illuminates and adding a predetermined time duration to the recorded time in calculating the time of the actual start of the race.
